(19) United States
(12) Patent Application Publication
(10) Pub. No.: US 2006/0279415 A1
(43) Pub. Date: Dec. 14, 2006

(54) Wait Staff Signaling Apparatus

(76) Inventor: Brenda Solheim, Santa Rosa, CA (US)

Correspondence Address: GARY HOENIG;HOENIG & ASSOCIATES, 2777 YULUPA AVE. 222, SANTA ROSA, CA, 95405, US

(21) Appl. No.: 11/422,409

(22) Filed: Jun. 6, 2006

Related U.S. Application Data
(60) Provisional application No. 60/595,104, filed on Jun. 6, 2005.

(51) Int. Cl. G08B 5/36

(52) U.S. Cl. 340/286.09

(57) ABSTRACT

A wait staff signaling apparatus and method used to summon wait staff to a restaurant table includes a housing having a plurality of signaling indicators wherein the indicators illuminate by means of a light source driven by a battery and function module when activated by a patron at the table by pressing or touching the respective switch. The indicators are color coded with the color codes corresponding to the type of service required by the patron. The wait staff is thereby facilitated to be alerted at a distance that service is required by the patron without requiring the wait staff to visit the table. The type of service required by the patron is also communicated to the wait staff by means of the color coding. The function module provides regulation of illumination intensity and power draw as well as optional features including battery management and flashing of the light source.

This Utility Patent Application, filed in the United States Patent and Trademark Office, is a continuation of Provisional Patent Application Ser. No. 60/595,104, filed Jun. 6, 2005 from which priority is claimed and incorporated herein in its entirety by reference.

### BACKGROUND OF THE INVENTION

The present invention relates to an apparatus and method of use thereof for facilitating restaurant wait staff notification of a patron requiring service and of the type of service required. More particularly, this invention is directed to an apparatus and method for communicating the service needs of a patron in a restaurant, or similar establishment.

Prior to the present invention, various systems have been proposed to summon restaurant wait staff to a table including radio frequency signal based or wired systems with activators at the table and visual indicators at central locations, and visual signaling systems located on the table being serviced. Radio signal based systems are expensive to install and are prone to interference resulting in unreliable operation. Wired systems are also expensive to install and typically restrict the reconfiguration of table locations due to the extensive wiring requirements.

Prior art table based signaling devices can generally be grouped as those that signal by means of a lit indicator and those that utilize a non-lit flagging element or marker. Non-lit devices are disadvantaged in restaurant environments where the tables are located in low lighting areas as wait staff may have difficulties identifying that a non-lit flagging or marker device has been activated. Depending upon the environment and construction an activated non-lit device does not draw attention as well as a lighted device. Lighted indicator signaling devices located at the table facilitate the wait staff to survey the tables from a distance to determine if service is required; however, the type of service required is not perceivable.

There are benefits to both the management and patrons of a restaurant to improve the communications between the wait staff and the patrons. Communications between the wait staff and the patron is improved by firstly identifying when the patron requires service and secondly reducing the time for wait staff to respond to the patron and thirdly communicating the type of service required. For example, a patron generally experiences frustration after having made a decision regarding what to order when attempting to raise the attention of wait staff to place the order is the wait staff does not respond quickly. This situation occurs because the patron does not have an effective way of communicating with the wait staff so the wait staff must observe the patron table from a distance and make a determination whether the patron is ready to order. If the wait staff approaches the table before a decision is made, then the patron may feel rushed while if the wait staff does not detect that a decision has been made, the patron may feel abandoned. Similar situations can occur during a meal. Wait staff must visit the table regularly or make a guess from afar to determine if service is required. A refill indicator effectively communicates the need to the wait staff thereby eliminating both the frustration of an empty drink by the patron and perceived poor service from the wait staff.

A particularly difficult period during a dining experience is the time between the end of a meal and paying the bill. Again, bringing the bill to the table too soon can have the effect of pushing a patron out of the restaurant and the associated disadvantages. Similarly, when a patron requires a bill, frustration may alternatively be experienced in communicating this need to the wait staff.

As illustrated, improved communications between the wait staff and the restaurant patron has many beneficiary effects including, but not limited to, an improved overall experience by the patron, increased patron count by decreasing the total meal time, and increased wait staff efficiency. What is needed is an improved portable low cost wait staff signaling apparatus and method locatable at the patron's table capable of communicating patron requests to the wait staff.

### SUMMARY OF THE INVENTION

Accordingly, the present invention is directed to wait staff signaling devices and methods and, more specifically, to a portable wait staff signaling apparatus located at a patron's table utilizing color coded illuminated indicators controllable by a patron and visible to wait staff used to attract the attention of wait staff and to communicate the type of service required, thereby substantially obviating one or more of the problems due to the limitations and disadvantages of the related art.

The present invention is a portable apparatus with a plurality of illuminating indicators controlled by the restaurant patron to indicate that service is required. The patron activates a self-powered illuminating indicator or indicators by means of activator switches which cause corresponding indicators to light. The need for service is signaled by activating the device and the type of service required is communicated by the color coding of the illuminated indicator and/or by the combinations of activated indicators. The apparatus is placed on the table by the wait staff and is activated by the patron. The illuminated indicator is typically deactivated after the service is provided or after attention of the wait staff is accomplished.

It is an object of the invention, therefore, to provide a new and improved visual signal device and method to attract the attention of wait staff to a given table whilst conveying to the wait staff, from a distance, that service is requested and the general type of service required without the necessity of wires, radio or other communications linking to a separate receiving system.

Another objective of the invention is to provide an illuminated indicator permits effective signaling in typical low light level restaurant environments where non-lit indicators are not useable.

A further objective is to minimize capital cost which is addressed by the low cost design. Because the invention is battery operated and a visual signal is utilized, the needs for power wiring and the needs for wired or radio linking to a central system are eliminated.

### BRIEF DESCRIPTION OF THE DRAWINGS

The accompanying drawings, which are incorporated in and constitute a part of this specification illustrate embodiments of the invention and, together with the description, serve to explain the features, advantages, and principles of the invention.

In the drawings:

FIG. 1 is a perspective view of the signaling device of this invention.

FIG. 2 is a front plan view of the signaling device of FIG. 1.

FIG. 3 is a side plan view of the signaling device of FIG. 1.

FIG. 4 is an enlarged partial top plan view of the signaling device of FIG. 1 showing optional word labeling and illuminator colors wherein SERVICE is color-coded white, REFILL is color-coded blue and CHECK is color-coded green as indicated by the shading.

FIG. 5 is a bottom plan view of the signaling device of FIG. 1.

FIG. 6 is an enlarged bottom plan view of the signaling device of FIG. 1, with the bottom cover plate and battery removed to show the activator switches and function modules.

FIG. 7 is an enlarged cross section view of the signaling device taken along Line 7-7 of FIG. 2 showing the activator push button switch and the light emitting diode light source with the energizing self-contained battery power supply and function module broken away and connective wires.

FIG. 8 is an enlarged cross section view of the signaling device taken along Line 8-8 of FIG. 5 showing fastening screws securing the bottom plate.

FIG. 9 is a simplified block diagram, partly schematic, of the signaling device of the preferred embodiment of the present invention with three illuminating indicators.

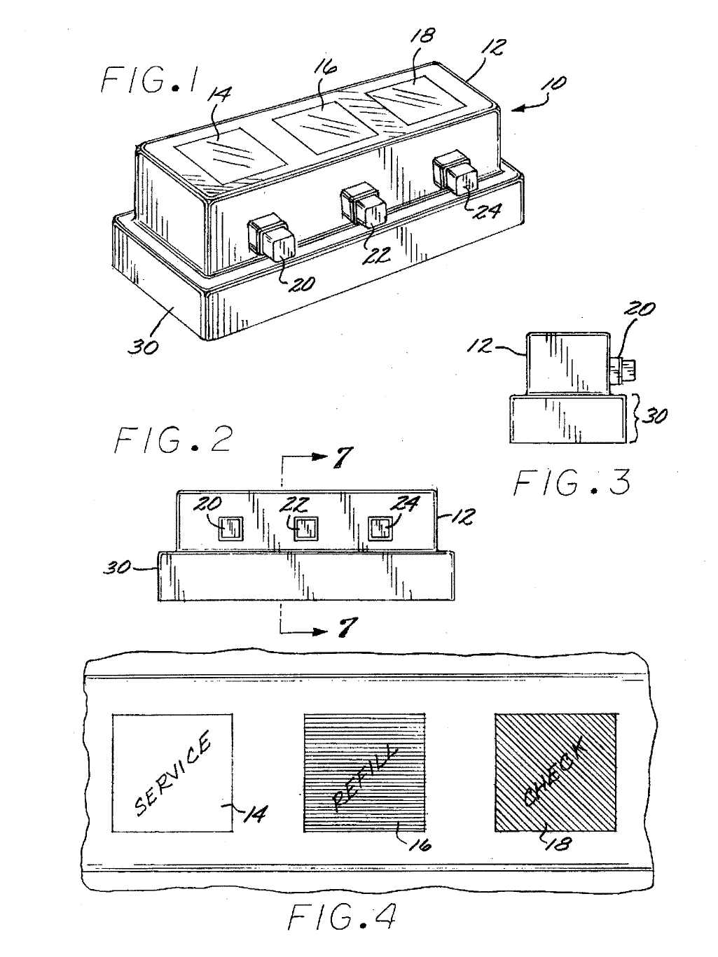

### DETAILED DESCRIPTION OF THE INVENTION

Although particular embodiments of the invention have been described in detail for purposes of illustration, various modifications may be made without departing from the spirit and scope of the invention. Accordingly, the invention is not to be limited except as by the appended claims. Referring now in greater detail to the various figures of the drawing wherein like reference characters refer to like parts, there is shown at 10 in FIG. 1, wait staff signaling apparatus constructed in accordance with the subject invention. Before describing the details of that apparatus it must be pointed out that while the apparatus is particularly suited for affecting wait staff signaling in restaurants, it can also be used for other applications wherein a server is providing service to patrons. Moreover, the subject invention may also be used for non-restaurant applications wherein patrons require a means of signaling service personnel, such as in waiting rooms.

The wait staff signaling apparatus 10 of the present invention and shown in FIG. 1, comprises a housing, a plurality of illuminating indicators mounted outwardly facing in the housing, a battery power supply mounted in the housing, wherein the illuminating indicators are comprised of a light source mounted behind a lens for filtering and directing the light emitted from the light source, a function module in electrical connectivity with the light source, and an activator switch mounted in the housing and in electrical connectivity with the function module with each function module in electrical connectivity with the battery power supply. Pressing or touching the switch activates the function module which is operable to activate the light source. The illuminating indicator is deactivated by pressing or touching the activator switch a second time.

Referring further to FIG. 1, the wait staff signaling apparatus, also referred to as the table unit, is shown in perspective wherein a first, second and third illuminating indicators 14, 16 and 18 are mounted in housing 12. The corresponding illuminating indicator lenses are back lit when the first, second and third activator switches 20, 22, or 24 are pressed. Further referring to FIG. 3, showing a side plan view of the present invention, the housing base portion 30 is expanded along the length and the width of the housing 12 so as to provide stability when the unit is placed on a surface.

The illuminating indicator lenses are translucent and colored with hues corresponding to the type of service required by the patron. When activated, the indicators produce a colored light the same color as the lens so that the color of the light is identifiable by the user prior to activation. Although any number of illuminating indicators may be incorporated in a particular embodiment; referring to FIG. 4, however, when three illuminating indicators are implemented, as in the preferred embodiment, the succession of color-coding is preferably white, blue and green representing the corresponding services of general service, refill required, and check required. Each indicator lens is respectively labeled “SERVICE”, “REFILL”, and “CHECK”. Any suitable color-coding and labeling scheme may be implemented as required. For example, the illuminator lenses may be labeled in the regional language or, in the alternative, labeled with symbols suggesting the service required.

In the preferred embodiment, the categories of services correspond generally to the order of events during a restaurant experience. General service refers to any service request communication typically encountered before the meal such as “ready to order” thereby eliminating unnecessary visits to the table by the wait staff to determine if the patrons are ready to order, while also eliminating the frustration of patron of raising the attention of the wait staff to place an order or other service need. During the meal the general service refers to “need service.” This is useful to signal for addition a variety of requests including “additional condiments” or “incorrect order.” The “refill required” and “check required” service indicators are similarly activated to communicate those needs.

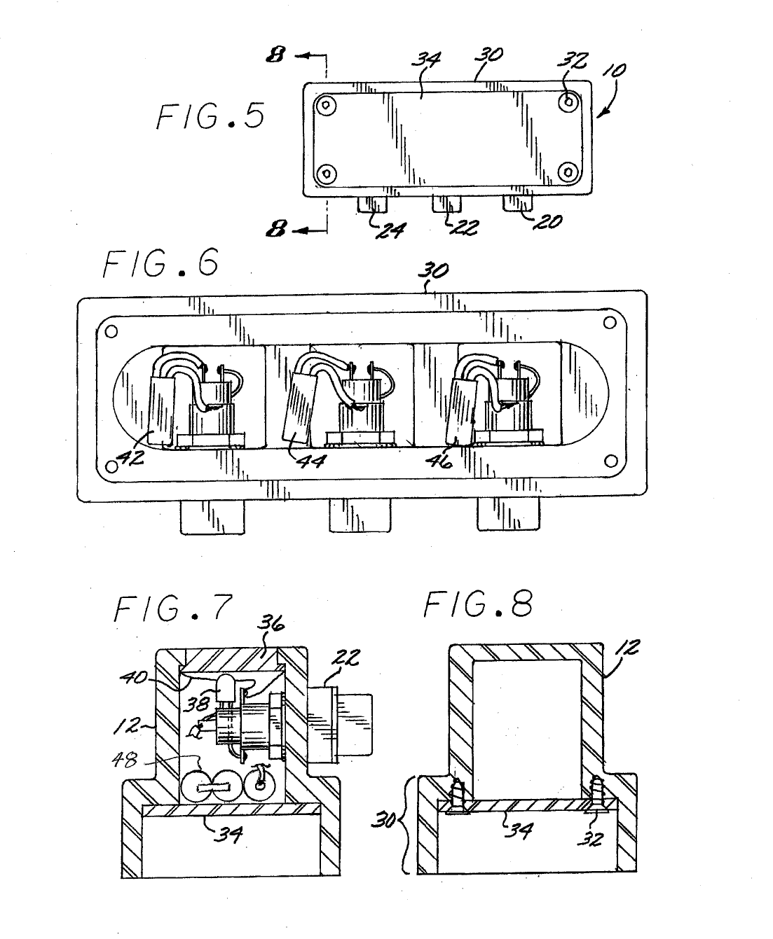

FIGS. 6 and 7 show the internal components wherein the battery power supply 48 and regulator function modules 42, 44 and 46 respectively electrically connected to switches 24, 22, and 20. Each illuminating indicator, typified by the REFILL indicator 16 of FIG. 4, further comprises a reflector 40, a light emitting diode as the light source 38 and a translucent color-coded lens 36, in this case colored blue representing “refill required.”

FIGS. 5 and 8 show details of the housing bottom plate 34 fastened to the housing 12 by means of a plurality of fasteners 32. The housing, having a top, a base portion, a length, a width and height is configured to conveniently house the essential components. The removable housing bottom plate 34 is recessed in the base portion 30 of the housing providing access for battery replacement. The housing is constructed of any convenient material such as metal or plastic. In the preferred embodiment, the illuminating indicators are mounted in the top sequentially along the length in the order white, blue and green. Facing upwardly, as in the preferred embodiment, the indicators are visible to observing wait staff from all directions around the table.

The housing base portion 30 being of expanded dimensions may optionally be engineered so as to form an opening of sufficient dimensions in length and width similar to the length and width of the top of the housing 12 permitting a unit to stack on top of another unit to minimize storage. Further, electrical contacts may optionally be arranged in the housing to provide electrical conductivity and connectivity between the housing and a separate battery charger base unit facilitating a means for charging rechargeable batteries in the table unit while not in use.

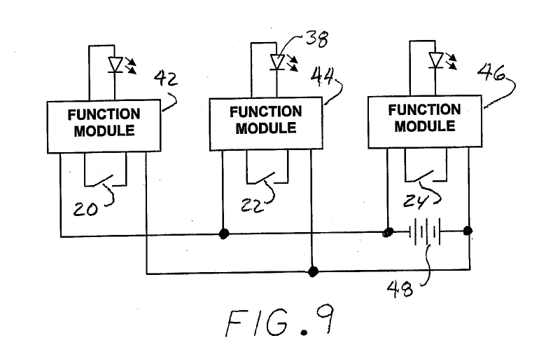

FIG. 9 shows a simplified block diagram and partial schematic of the electrical connectivity of the internal components of the present invention having three illuminating indicator assemblies. Selecting function module 44 as an example, the function module, in the simplest form, regulates the intensity of the light source and the delivery of power from the battery 48 to the light emitting diode light source 38 when activated by the switch 22 so as to maximize the life of both the light source and the battery.

Additional functions are added to the present invention by providing function modules with particular features. For example, a module may be added to flash the light source after a predetermined amount of time after activation. Another module may provide steady or variable flash rates to the light source depending upon the amount of time the indicator has been active. An alternate module may be added to shut an indicator off at a predetermined interval so as to conserve the battery power supply. The addition of programmable control function modules permits the table unit to be customized to best suit a particular customer's needs.

The preferred method of using the present invention comprises the steps of the wait staff placing the wait staff signaling apparatus on the table being serviced, instructing the patrons to activate an illuminating indicator when service is require wherein the indicator corresponds to the type of service required, monitoring by the wait staff for the presence of an activated indicator, observing by the wait staff the color of the activated indicator, responding by the wait staff with the appropriate service to the requesting table as communicated by the activated indicator and its color, and deactivating by the wait staff the activated indicator after the service is provided.

Alternate embodiments of the method of use for the present invention such as activation of a plurality of indicators to communicate other types of or variations of services may also be implemented as required.

What is claimed is:

1. A wait staff signaling apparatus comprising;
a housing,
a plurality of illuminating indicators mounted outwardly facing in the housing wherein the illuminating indicators comprise a light source and translucent lens mounted to filter and direct the light emitted from the light source; each indicator having a function module in electrical connectivity with the light source for regulating the intensity of the light source and the consumption of power drawn, each indicator further having a switch mounted in the housing being in electrical connectivity with the function module which is operable to activate the light source when activated by the switch; and
a battery mounted in the housing and in electrical connectivity with each illuminating indicator function module.

2. The wait staff signaling apparatus according to claim 1, wherein the light source is a light emitting diode.

3. The wait staff signaling apparatus according to claim 1, wherein the illuminating indicator lenses are translucent and colored.

4. The wait staff signaling apparatus as in claim 1, wherein the apparatus has a first illuminating indicator colored white and produces a white illumination, a second illuminating indicator colored blue and produces a blue illumination, and a third illuminating indicator colored green and produces a green illumination.

5. The wait staff signaling apparatus as in claim 4, wherein the color white represents SERVICE, the color blue represents REFILL, and the color green represents CHECK.

6. The wait staff signaling apparatus as in claim 3, wherein the apparatus has a first illuminating indicator labeled SERVICE, a second illuminating indicator labeled REFILL, and a third illuminating indicator labeled CHECK.

7. The wait staff signaling apparatus as in claim 3, wherein the apparatus has a first illuminating indicator with a symbol representing SERVICE, a second illuminating indicator with a symbol representing REFILL, and a third illuminating indicator with a symbol representing CHECK.

8. The wait staff signaling apparatus according to claim 1, wherein the battery is rechargeable.

9. The wait staff signaling apparatus according to claim 1, wherein the function modules are further operable to flash the light source at steady or variable rates.

10. The wait staff signaling apparatus according to claim 1, wherein the function modules are further operable to deactivate the light source after a predetermined interval.

11. A method of signaling wait staff, using the apparatus of claim 1, comprising the steps of placing the wait staff signaling apparatus on the table being serviced, instructing the patrons to activate an illuminating indicator when service is require wherein the indicator corresponds to the type of service required, monitoring by the wait staff for the presence of an activated indicator, observing by the wait staff the color of the activated indicator, responding by the wait staff with the appropriate service to the requesting table as communicated by the activated indicator, and deactivating by the wait staff the activated indicator after the service is provided.
